(19) United States
(12) Patent Application Publication
(10) Pub. No.: US 2013/0114938 A1
(43) Pub. Date: May 9, 2013

(54) IMAGE-CAPTURING APPARATUS

(71) Applicant: NIKON CORPORATION, Tokyo (JP)

(72) Inventor: Takashi KURIYAMA, Yokohama-shi (JP)

(73) Assignee: NIKON CORPORATION, Tokyo (JP)

(21) Appl. No.: 13/667,698

(22) Filed: Nov. 2, 2012

(30) Foreign Application Priority Data
Nov. 8, 2011 (JP) 2011-244439
Aug. 31, 2012 (JP) 2012-191980

(51) Int. Cl. H04N 5/77

(52) U.S. Cl. 386/225; 386/E05.069

(57) ABSTRACT

An image-capturing apparatus includes: a storage unit into which a plurality of image frames, generated based upon imaging signals provided from an image sensor that captures a subject image via a photographic optical system, are sequentially stored; an optical system drive unit that drives the photographic optical system in response to a still image shooting instruction; and a video data generation unit that generates image data to be played back in time series based upon the plurality of image frames stored into the storage unit over a predetermined time length during which the still image shooting instruction is issued.

### INCORPORATION BY REFERENCE

The disclosures of the following priority applications are herein incorporated by reference: Japanese Patent Application No. 2011-244439 filed Nov. 8, 2011 and Japanese Patent Application No. 2012-191980 filed Aug. 31, 2012.

### BACKGROUND OF THE INVENTION

1. Field of the Invention

The present invention relates to an image-capturing apparatus.

2. Description of Related Art

The apparatuses relevant to the present invention known in the related art include, for instance, the imaging apparatus disclosed in Japanese Laid Open Patent Publication No. 2010-272999. This particular imaging apparatus records video at a high frame rate while a zoom lens is moving but records video at a low frame rate while the zoom lens is stationary. When playing back a video, the imaging apparatus simply plays frames recorded at a low frame rate at the same low frame rate and plays frames recorded at the high frame rate in slow-motion playback.

### SUMMARY OF THE INVENTION

The technology known in the related art cannot easily be adopted in a video recording operation started in response to a still image-capturing instruction.

According to the first aspect of the present invention, an image-capturing apparatus comprises: a storage unit into which a plurality of image frames, generated based upon imaging signals provided from an image sensor that captures a subject image via a photographic optical system, are sequentially stored; an optical system drive unit that drives the photographic optical system in response to a still image shooting instruction; and a video data generation unit that generates image data to be played back in time series based upon the plurality of image frames stored into the storage unit over a predetermined time length during which the still image shooting instruction is issued.

According to the second aspect of the present invention, in the image-capturing apparatus according to the first aspect, it is preferred that the video data generation unit generates slow-motion video data to be played back at a second frame rate lower than a first frame rate indicating a number of image frames, among the plurality of image frames, which are stored over unit time into the storage unit.

According to the third aspect of the present invention, in the image-capturing apparatus according to the second aspect, it is preferred that the image-capturing apparatus further comprises a still image generation unit that generates a minimum of one set of still image data based upon at least one image frame among the plurality of image frames having been stored into the storage unit over the predetermined time length.

According to the fourth aspect of the present invention, in the image-capturing apparatus according to the third aspect, it is preferred that the still image data generation unit generates the minimum of one set of still image data based upon an image frame stored into the storage unit before the optical system drive unit drives the photographic optical system and an image frame stored into the storage unit after the optical system drive unit drives the photographic optical system.

According to the fifth aspect of the present invention, in the image-capturing apparatus according to the fourth aspect, it is preferred that the minimum of one set of still image data generated by the still image data generation unit contains two sets of still image data; and the still image data generation unit generates one of the two sets of still image data based upon the image frame stored into the storage unit before the optical system drive unit drives the photographic optical system and generates another of the two sets of still image data based upon the image frame stored into the storage unit after the optical system drive unit drives the photographic optical system.

According to the sixth aspect of the present invention, in the image-capturing apparatus according to the third aspect, it is preferred that the image-capturing apparatus further comprises a recording control unit that records the slow-motion video data generated by the video data generation unit and the minimum of one set of still image data generated by the still image data generation unit into a recording medium by correlating the slow-motion video data with the still image data.

According to the seventh aspect of the present invention, in the image-capturing apparatus according to the first aspect, it is preferred that the optical system drive unit drives at least either a focusing lens or a zoom lens in the photographic optical system in response to the still image shooting instruction.

According to the eighth aspect of the present invention, in the image-capturing apparatus according to the first aspect, it is preferred that the image-capturing apparatus further comprises an altering means for altering at least one value of an exposure value and a white balance value. The altering means alters the at least one value while the predetermined time length over which the plurality of image frames are sequentially stored into the storage unit elapses.

### BRIEF DESCRIPTION OF THE DRAWINGS

FIG. 1 is a block diagram presenting an example of a structure that may be adopted in the digital camera achieved in a first embodiment of the present invention.

FIG. 2 illustrates the timing with which images are obtained in a slow-motion video shooting mode.

FIG. 3 illustrates how a first focus detection point may be set.

FIG. 4 illustrates how a second focus detection point may be set.

FIG. 5 presents a flowchart of the processing executed by the CPU.

FIG. 6 presents a flowchart of the processing executed by the CPU in the digital camera achieved in a second embodiment.

FIG. 7 presents an example of a mark that may be brought up on display at the liquid crystal monitor.

FIG. 8 presents an example of a zoomed-in image.

FIG. 9 illustrates how the first focus detection point may be set at the digital camera achieved in a third embodiment.

FIG. 10 illustrates how focus may be adjusted for the second focus detection point at the digital camera achieved in the third embodiment.

### DESCRIPTION OF PREFERRED EMBODIMENTS

The following is a description of embodiments of the present invention given in reference to the drawings.

### First Embodiment

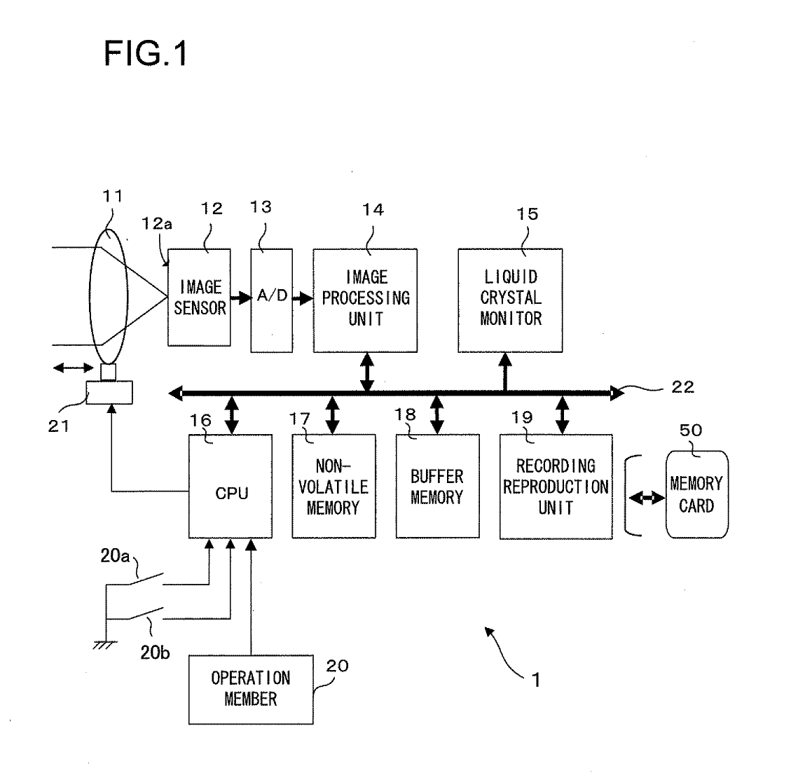

FIG. 1 is a block diagram showing a structure that may be adopted in a digital camera 1 achieved in the first embodiment of the present invention. A photographic lens 11 in FIG. 1 forms a subject image at an image-capturing surface 12a of an image sensor 12. It is to be noted that the photographic lens 11 in the digital camera 1 shown in FIG. 1 is an integrated lens provided as an integrated part of the camera. In other words, the photographic lens 11 cannot be detached from the digital camera 1. However, the structure of the digital camera 1, which will be described in detail later, may be adopted in a camera system including a camera body and an interchangeable lens that can be detachably mounted at the camera body. In such a case, the photographic lens 11 and a lens drive unit 21 in FIG. 1 will be included as part of the interchangeable lens, whereas the image sensor 12, an image processing unit 14, a liquid crystal monitor 15, a CPU 16, a buffer memory 18, a recording reproduction unit 19 and an operation member 20 in FIG. 1 will be disposed at the camera body.

As a halfway press switch 20a enters an on state by interlocking with a halfway press operation of a shutter button (not shown), the CPU 16 executes autofocus (AF) processing through which a focusing lens (not shown) constituting the photographic lens 11 is driven forward/backward along the optical axis (indicated by an arrow in FIG. 1). As a result, the focal position is automatically adjusted for the photographic lens 11. The focusing lens (not shown) is driven by the lens drive unit 21 in response to an instruction issued by the CPU 16.

The AF processing is executed through an image-capturing surface phase-difference detection method. For this purpose, the image sensor 12 includes focus detection pixels. The focus detection pixels may be similar to, for instance, the focus detection pixels disclosed in Japanese Laid Open Patent Publication No. 2007-317951. The CPU 16 detects the focusing condition of the photographic lens 11 (to be more specific, the defocus amount indicating the extent of defocusing) through phase-difference detection operation executed by using output signals provided from the focus detection pixels. Since the phase-difference detection operation can be executed in much the same way as the focus detection operation disclosed in, for instance, Japanese Laid Open Patent Publication No. 2007-317951 cited above, a repeated explanation is not provided.

In addition, when an operation signal has been input from a zoom switch (not shown) included in the operation member 20 to be described in detail later, or when a slow-motion video shooting operation is to be executed based upon field angle information set in advance, the CPU moves a zoom lens (not shown) included in the photographic lens 11 forward/backward along the optical axis. As a result, the angle of photographic field is adjusted. The zoom lens (not shown), too, is driven by the lens drive unit 21 in response to an instruction issued by the CPU 16. The slow-motion video shooting operation will be described in detail later.

The image sensor 12 is constituted with a CMOS image sensor or the like. The image sensor 12 converts the subject image formed on the image-capturing surface 12a to analog image-capturing signals through photoelectric conversion. The analog image-capturing signals output from the image sensor 12 are then converted to digital image data at an A/D conversion unit 13. The image processing unit 14 generates image data by executing a specific type of image processing on the digital image data.

At the liquid crystal monitor 15, an image or an operation menu screen is brought up on display in response to an instruction issued by the CPU 16. In a nonvolatile memory 17, a program to be executed by the CPU 16, data required in program execution processing and the like are stored. An addition can be made to the contents of the program or the data stored in the nonvolatile memory 17 and/or the contents of the program or the data can be modified in response to an instruction from the CPU 16. The CPU 16 executes a control program by using, for instance, the buffer memory 18 as a work area so as to control the various units constituting the camera.

In the buffer memory 18, digital image data are temporarily stored under control executed by the CPU 16. In the embodiment, pre-captured images obtained at a predetermined frame rate via the image sensor 12 before a shooting instruction is issued (before the shutter button is pressed all the way down) are temporarily stored (buffered) into the buffer memory 18. A more detailed explanation on pre-captured images will be provided later.

In addition to executing the image processing on the digital image data, the image processing unit 14 creates an image file in a predetermined format (e.g., an Exif file) having image data stored therein. Based upon an instruction issued by the CPU 16, the recording reproduction unit 19 records an image file into a memory card 50 or reads out an image file recorded in the memory card 50.

The memory card 50 is a detachable recording medium that can be loaded into a card slot (not shown). Based upon an image file read out from the memory card 50 by the recording reproduction unit 19, the CPU 16 reproduces a photographic image and displays the reproduced photographic image at the liquid crystal monitor 15.

The operation member 20, which includes a plurality of members such as the halfway press switch 20a (switch S1) mentioned earlier, a full press switch 20b (switch S2) that is turned on as the shutter button is pressed all the way down, a video shooting switch and a mode selector switch, outputs an operation signal generated as the user operates a specific member among the plurality of members, to the CPU 16.

An on signal (halfway press operation signal) is output from the halfway press switch 20a as the shutter button is pressed down to a position approximately halfway through a full stroke. The output of the halfway press operation signal is cleared when the shutter button is no longer held at the halfway stroke position. An on signal (full-press operation signal) is output from the full press switch 20b as the shutter button reaches the full stroke position and the output of the full-press operation signal is cleared when the shutter button is no longer held at the full stroke position.

(Shooting Modes) A still image shooting mode, a video shooting mode or a slow-motion video shooting mode can be selected at the digital camera 1 via the mode selector switch mentioned earlier. In the still image shooting mode, an image is obtained at the image sensor 12 in response to the full-press operation signal and still image data generated by the image processing unit 14 based upon the image obtained at the image sensor 12 are recorded into the memory card 50 by the recording reproduction unit 19.

In the video shooting mode, a plurality of image frames are obtained at the image sensor 12 in response to an operation signal output from the video shooting switch (not shown) mentioned earlier and video data generated by the image processing unit 14 based upon the plurality of image frames are recorded into the memory card 50 by the recording reproduction unit 19.

In the slow-motion video shooting mode, the image processing unit 14 generates both slow-motion video data and still image data based upon a plurality of image frames obtained via the image sensor 12 over a predetermined length of time between time points before and after an output of the full-press operation signal and the recording reproduction unit 19 records the slow-motion video data and the still image data into the memory card 50 by correlating them to each other. In the description of the present invention, video data that are played back at a frame rate lower than the frame rate at which the initial images having been obtained will be referred to as slow-motion video data. In the embodiment, slow-motion video data, generated based upon a plurality of image frames having been obtained at, for instance, 60 frames/sec (60 fps), which will be played back at 24 frames/sec (24 fps) by the recording reproduction unit 19 in response to an instruction issued by the CPU 16.

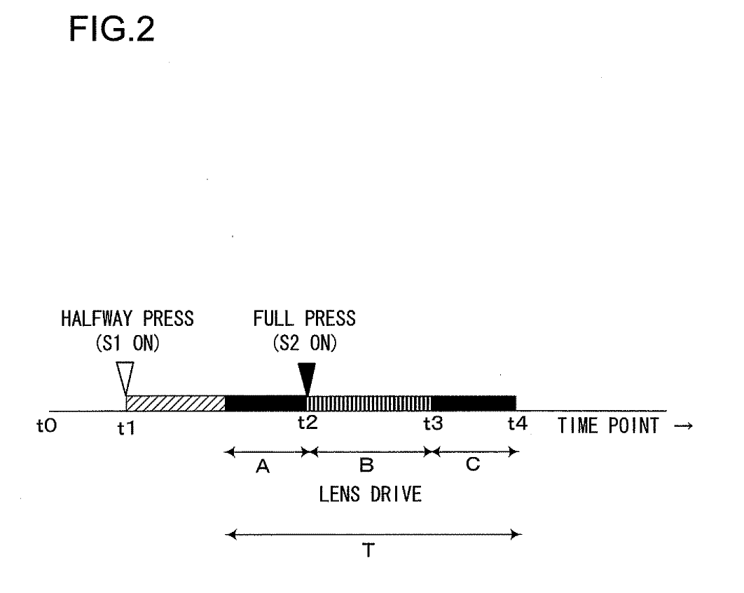

Since the digital camera 1 in the embodiment is characterized by its operation executed in the slow-motion video shooting mode, the following explanation will focus on the slow-motion video shooting mode. FIG. 2 illustrates the timing with which images are obtained in the slow-motion video shooting mode.

(Setting focus detection points) As the slow-motion video shooting mode is selected at a time point t0 in FIG. 2, the CPU 16 starts displaying a live view image at the liquid crystal monitor 15. The CPU 16 engages the image sensor 12 in image-capturing operation so as to capture the subject image at a frame rate of, for instance, 60 frames/see (60 fps) and displays a live view image at the liquid crystal monitor 15 by sequentially bringing up images reproduced based upon resulting digital image data. In addition, the CPU 16 executes exposure control so as to achieve the optimal exposure by executing exposure calculation based upon the digital image data.

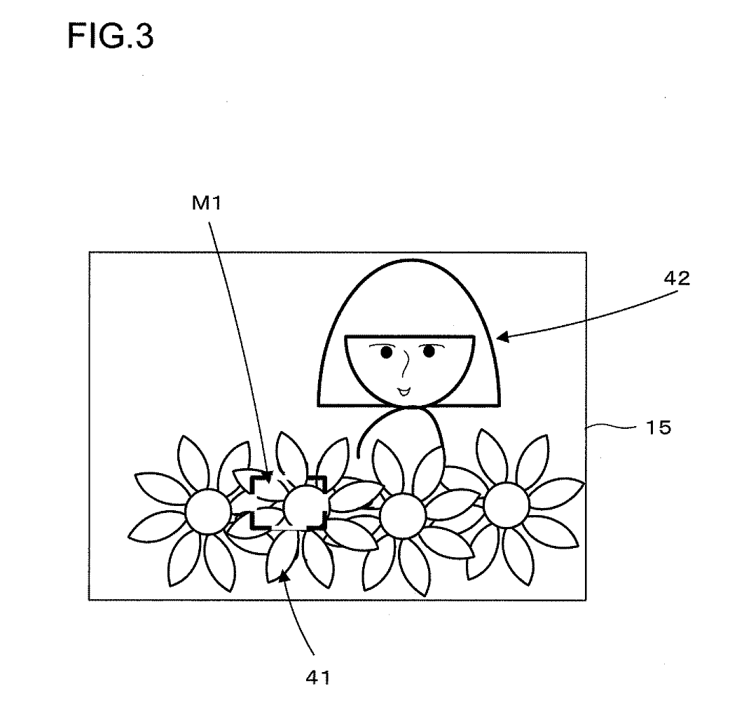

While the live view image is up on display at the liquid crystal monitor 15, the CPU 16 accepts an operation performed so as to set a first focus detection point as the target of first AF processing to be executed in response to a halfway press operation of the shutter button. The first focus detection point is set as in the example presented in FIG. 3 by moving the position of a mark M1 representing the first focus detection point on a live view image on display at the liquid crystal monitor 15. The position of the mark M1 can be moved in correspondence to, for instance, the operating direction indicated via a cross key (not shown) included in the operation member 20. FIG. 3 illustrates how the first focus detection point may be set. The first focus detection point may be set on, for instance, a closer-range subject 41 in the embodiment. The closer-range subject 41 is present between a longer-range subject 42 and the digital camera 1.

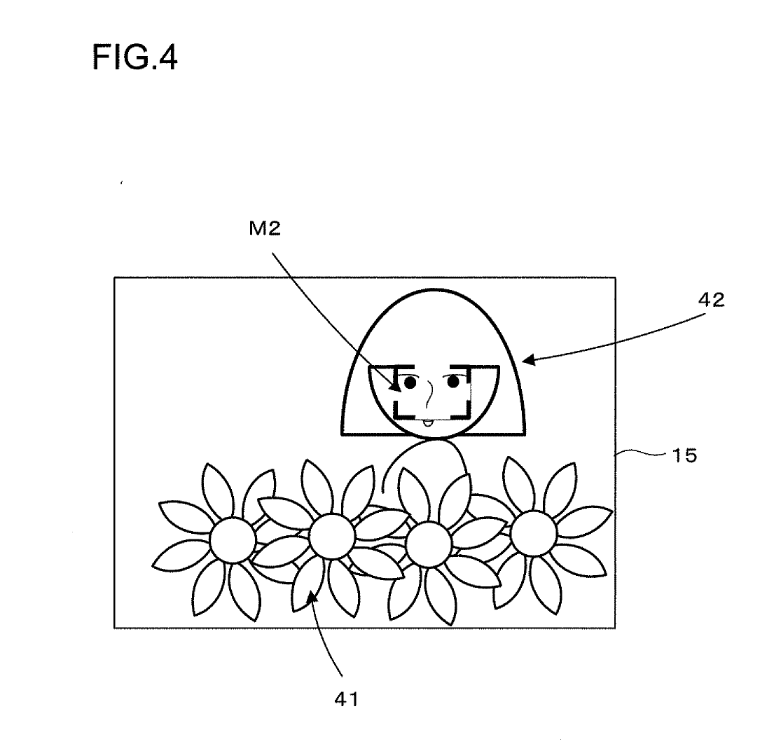

The CPU 16 further accepts an operation performed so as to set a second focus detection point as the target of second AF processing to be executed in response to a full-press operation of the shutter button. The second focus detection point is set as in the example presented in FIG. 4 by moving the position of a mark M2 representing the second focus detection point on the live view image on display at the liquid crystal monitor 15. The first focus detection point setting can be switched to the second focus detection point setting and vice versa by operating, for instance, a focus detection point selector switch (not shown) included in the operation member 20. FIG. 4 illustrates how the second focus detection point may be set. The second focus detection point may be set on, for instance, the longer-range subject 42 in the embodiment.

(Focus adjustment and pre-capture operation) As the user presses the shutter button halfway down (switch S1 on) at a time point t1 in FIG. 2, the CPU 16 executes the first AF processing by using output signals provided from focus detection pixels corresponding to the first focus detection point. In more specific terms, the CPU 16 calculates through arithmetic operation a focusing lens drive quantity (i.e., the defocus amount) by executing AF operation based upon the output signals provided from the focus detection pixels corresponding to the first focus detection point (the position of the mark M1 in FIG. 3). The CPU 16 then engages the lens drive unit 21 so as to drive the focusing lens in the photographic lens 11 based upon the defocus amount and, as a result, focus is adjusted to the closer-range subject 41 in FIG. 3. At this time, the longer-range subject 42 is outside the range of the depth of field and thus focus is not adjusted to the longer-range subject 42 in the embodiment. Once the focusing lens is moved to the focusing position determined based upon the defocus amount calculated for the closer-range subject 41, the CPU 16 starts recording (storing) image data obtained via the image sensor 12 into the buffer memory 18. Through this process, image frame of obtained at the frame rate of 60 frames/sec (60 fps) are sequentially stored into the buffer memory 18. The number of pixels constituting each image frame stored into the buffer memory 18 may be, for instance, 3840 (horizontal)×2160 (vertical).

A sufficient memory space is secured in advance in the buffer memory 18 for images to be obtained through pre-capture operation. Once the number of image frames stored into the buffer memory 18 following the time point t1 reaches a predetermined value (e.g., 300 frames (accumulated over a 5-sec period)), the CPU 16 starts sequentially erasing the oldest image frames in the buffer memory 18 by writing new images over them. Through these measures, it is ensured that only a limited memory space in the buffer memory 18 is used to store the images obtained through the pre-capture operation.

(Focus shift to a different subject) As the user presses the shutter button all the way down (switch S2 on) at a time point t2, the CPU 16 executes the second AF processing by using output signals provided from focus detection pixels corresponding to the second focus detection point. More specifically, the CPU 16 calculates through arithmetic operation a focusing lens drive quantity (i.e., the defocus amount) by executing AF operation based upon the output signals provided from the focus detection pixels corresponding to the second focus detection point (the position of the mark M2 in FIG. 4). The CPU 16 then engages the lens drive unit 21 so as to drive the focusing lens in the photographic lens 11 based upon the defocus amount and, as a result, focus is adjusted to the longer-range subject 42 in FIG. 4. At this time, the closer-range subject 41 is outside the range of the depth of field and thus focus is not adjusted to the closer-range subject 41 in the embodiment. A focus detection position shift operation (i.e., a condition change from the state at which the closer-range subject 41 is in focus to the state at which the longer-range subject 42 is in focus) in the embodiment, started at the time point t2, is executed by the CPU 16, as it engages the lens drive unit 21 in continuous drive of the focusing lens from the time point t2 through a time point t3. While this focus detection position shift operation is in progress, the image sensor 12 is continuously engaged in image-capturing operation and image data are continuously stored (accumulated) into the buffer memory 18 on a temporary basis. The predetermined length of time B elapsing between the time point t2 and the time point t3 may be set to, for instance, 1 second in the embodiment.

(Post-capture operation) Once the focusing lens is driven to the focusing position determined based upon the defocus amount calculated for the longer-range subject 42, the CPU 16 starts a timer count at the time point t3 via a timer circuit (not shown) within the CPU 16. At a time point t4 at which the timer circuit finishes the time count following a predetermined length of time C (e.g. 0.5 sec), the CPU 16 ends the image data accumulation in the buffer memory 18.

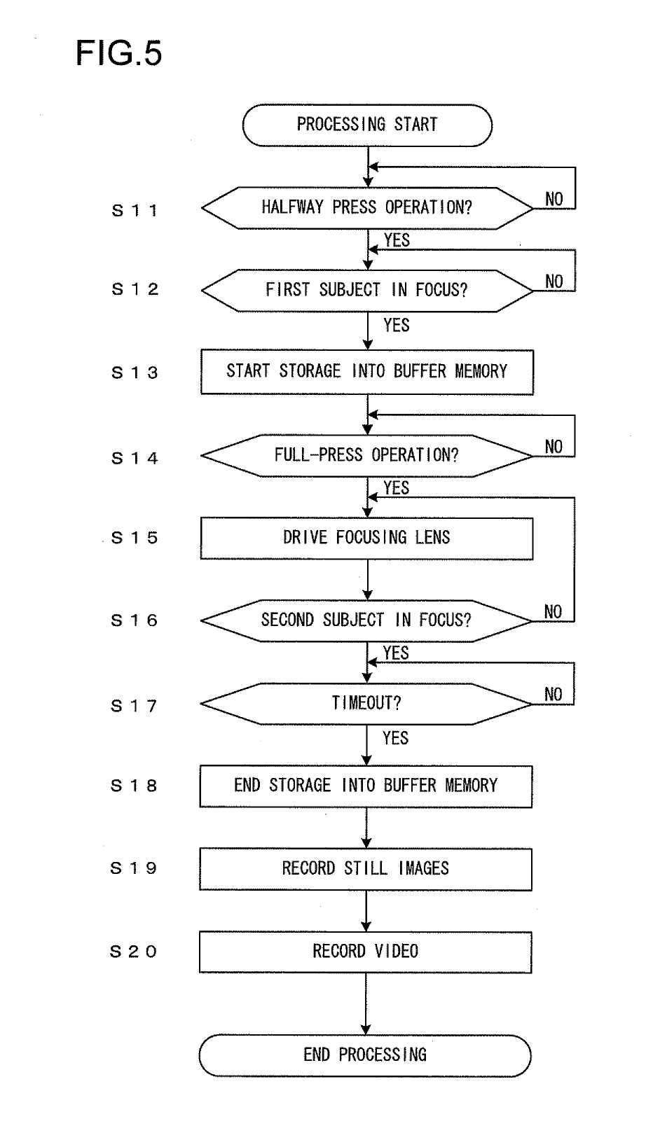

In reference to the flowchart presented in FIG. 5, the flow of processing that may be executed by the CPU 16 during the slow-motion video shooting sequence is described. Once the camera is switched to the slow-motion shooting mode, the CPU 16 repeatedly executes a program enabling the processing shown in FIG. 5. In step S11 in FIG. 5, the CPU 16 starts a live view image display at the liquid crystal monitor 15 and makes a decision as to whether or not the shutter button has been pressed halfway down. If an operation signal from the halfway press switch 20a has been input thereto, the CPU 16 makes an affirmative decision in step S11 and proceeds to execute the processing in step S12. However, if no operation signal from the halfway press switch 20a has been input, the CPU 16 makes a negative decision in step S11 and subsequently repeatedly executes the decision-making processing.

In step S12, the CPU 16 starts the first AF processing described earlier and makes a decision as to whether or not a first subject has been in focus. Once the focusing lens is moved to the focusing position, the CPU 16 makes an affirmative decision in step S12 and proceeds to execute the processing in step S13. As a result, focus is adjusted to the closer-range subject 41 (see FIG. 3). If, on the other hand, the focusing lens is still moving toward the focusing position, the CPU 16 makes a negative decision in step S12 and in this case, it repeatedly executes the decision-making processing.

In step S13, the CPU 16 starts image data storage into the buffer memory 18 and then proceeds to execute the processing in step S14. In step S14, the CPU 16 makes a decision as to whether or not the shutter button has been pressed all the way down. If an operation signal from the full press switch 20b has been input thereto, the CPU 16 makes an affirmative decision in step S14 and proceeds to execute the processing in step S15. However, if no operation signal from the full press switch 20b has been input, the CPU 16 makes a negative decision in step S14 and subsequently repeatedly executes the decision-making processing.

In step S15, the CPU 16 starts the second AF processing described earlier and engages the lens drive unit 21 so as to drive the focusing lens over a predetermined length of time B (e.g., 1 second as explained earlier) before proceeding to execute the processing in step S16. In step S16, the CPU 16 makes a decision as to whether or not a second subject has been in focus through the second AF processing. Once the focusing lens is moved to the focusing position, the CPU 16 makes an affirmative decision in step S16 and proceeds to execute the processing in step S17. As a result, focus is adjusted to the longer-range subject 42 (see FIG. 4). If, on the other hand, the focusing lens is still moving toward the focusing position, the CPU 16 makes a negative decision in step S16 and in this case, the operation returns to step S15.

In step S17, the CPU 16 makes a decision as to whether or not the operation has timed out. If the time count over the predetermined length of time C, having been started at the time point t3, has ended, the CPU 16 makes an affirmative decision in step S17 and proceeds to execute the processing in step S18. If, on the other hand, the time count over the length of time C has not yet ended, the CPU 16 makes a negative decision in step S17 and in this case, repeatedly executes the decision-making processing.

In step S18, the CPU 16 ends the image data storage into the buffer memory 18, and then proceeds to execute the processing in step S19. In step S19, the CPU 16 outputs an instruction for the image processing unit 14, prompting the image processing unit 14 to generate still image data, as will be described in further detail later, based upon the image data having accumulated in the buffer memory 18, and engages the recording reproduction unit 19 to record the still image data thus generated into the memory card 50.

In step S20, the CPU 16 outputs an instruction for the image processing unit 14, prompting the image processing unit 14 to generate slow-motion video data, as will be described in further detail later, based upon the image data having accumulated in the buffer memory 18, and engages the recording reproduction unit 19 to record the slow-motion video data thus generated into the memory card 50. The CPU 16 controls the recording reproduction unit 19 so as to record the slow-motion video data and the still image data into the memory card 50 by correlating the slow-motion video data with the still image data before the processing shown in FIG. 5 ends. The still image data include first still image data and second still image data, as will be explained later.

(Generation of slow-motion video data) The CPU 16 outputs an instruction for the image processing unit 14, prompting the image processing unit 14 to generate slow-motion video data, to be played at 24 frames/sec, based upon an image frame group made up with image frames obtained over a predetermined length of time A (e.g. 0.5 sec in FIG. 2) preceding the time point t2, an image frame group made up with image frames obtained over the predetermined length of time B (e.g., 1 sec as explained earlier) elapsing between the time point t2 and the time point t3 and an image frame group made up with image frames obtained over the predetermined length of time C (0.5 sec as explained earlier) elapsing between the time point t3 and the time point t4, all having been stored into the buffer memory 18. As a result, slow-motion video data to be played over a running time of, for instance, 5 seconds, are obtained based upon the groups of image frames having been obtained over a time period T (=A+B+C)=2 seconds.

In conjunction with image data output from the image sensor 12 expressing images each made up with, for instance, 3840 pixels (horizontal)×2160 pixels (vertical), the image processing unit 14 executes a specific type of image processing on images resulting from resize processing executed to halve the number of pixels along the horizontal direction and the vertical direction, so as to create slow-motion video data conforming to the “high definition” standard (1920 pixels (horizontal)×1080 pixels (vertical)).

(Generation of still image data) In addition, the CPU 16 outputs an instruction for the image processing unit 14, prompting the image processing unit 14 to obtain first still image data constituting 3840 pixels (horizontal)×2160 pixels (vertical) by extracting a single image frame in the group of images (the image group made up with a plurality of image frames in which focus is adjusted to the closer-range subject 41) made up with a plurality of image frames having been obtained over the predetermined length of time A elapsing before the time point t2 (i.e., prior to the full-press operation), stored into the buffer memory 18. The single image frame extracted by the image processing unit 14 may be the image in the last frame among the images obtained during the predetermined time length. A or it may be a best-shot image (a best shot image among the images obtained during the predetermined time length A) extracted based upon predetermined selection criteria from the images obtained during the predetermined time length A.

Furthermore, the CPU 16 outputs an instruction for the image processing unit 14, prompting the image processing unit 14 to obtain second still image data constituting 3840 pixels (horizontal)×2160 pixels (vertical), by extracting a single image frame in the group of images (the image group made up with a plurality of image frames in which focus is adjusted to the longer-range subject 42) made up with a plurality of image frames having been obtained over the predetermined length of time C elapsing after the time point t3 (i.e., following the full-press operation), stored into the buffer memory 18. The single image frame extracted by the image processing unit 14 may be the image in the first frame among the images obtained during the predetermined time length C or it may be a best-shot image extracted based upon predetermined selection criteria from the images obtained during the predetermined time length C.

The CPU 16 brings up on display at the liquid crystal monitor 15 images reproduced based upon the slow-motion video data and the first and second still image data recorded into the memory card 50 in correlation to each other as has been explained above. For instance, the CPU 16 may display the image generated based upon the first still image data for two seconds, play the video based upon the slow-motion video data for five seconds and then display the image generated based upon the second still image data over the subsequent two-second period at the liquid crystal monitor 15.

The CPU 16 in the embodiment is able to select, in response to an operation signal output from the operation member 60, a first recording method whereby the recording reproduction unit 19 records the slow-motion video data, the first still image data and the second still image data into the memory card 50, a second recording method whereby the recording reproduction unit 19 records the slow-motion video data and the first still image data into the memory card 50, or a third recording method whereby the recording reproduction unit 19 records the slow-motion video data and the second still image data into the memory card 50. The embodiment has been described by assuming that the first recording method has been selected.

The following advantages are achieved through the first embodiment described above.

(1) The digital camera 1 is equipped with a buffer memory 18 into which a plurality of image frames, generated based upon imaging signals provided from the image sensor 12, which captures a subject image via the photographic lens 11, are sequentially stored, a lens drive unit 21 that drives the photographic lens 11 in response to a still image shooting instruction and an image processing unit 14 that generates slow-motion video data to be played back in time series at a frame rate of 24 fps, lower than the 60 fps at which the plurality of image frames are stored into the buffer memory 18 in unit time, based upon the plurality of image frames stored into the buffer memory 18 over the predetermined time length B, during which the still image shooting instruction is issued at the time point t2. Thus, a time-series image achieving a striking motion picture effect can be obtained automatically with the timing with which a still image is shot.

(2) The image processing unit 14 in the digital camera 1 described in (1) above generates at least one set of still image data based upon the plurality of image frames stored into the buffer memory 18 during the above predetermined time length. Thus, a still image closely linked to the time-series image is obtained.

(3) The image processing unit 14 in the digital camera 1 described in (2) above generates at least one set of still image data, i.e., either the first still image data or the second still image data, based upon the image frames stored into the buffer memory 18 during the predetermined time length A elapsing before the lens drive unit 21 drives the photographic lens 11 or the image frames stored into the buffer memory 18 over the predetermined time length C after the lens drive unit 21 drives the photographic lens 11. Consequently, a still image closely linked to the time-series image, captured either before or after the photographic lens 11 is driven, is obtained.

(4) The at least one set of still image data in the digital camera 1 described in (3) above includes two sets of still image data. The image processing unit 14 generates the first still image data, which is one of the two sets of still image data, based upon the image frames stored into the buffer memory 18 over the predetermined time length A elapsing before the lens drive unit 21 drives the photographic lens 11 and generates the second still image data, which is one of the two sets of still image data, based upon the image frames stored into the buffer memory 18 after the lens drive unit 21 drives the photographic lens 11. Thus, a still image closely linked to the time-series image can be obtained based upon the images captured before or after the photographic lens 11 is driven.

(5) The digital camera 1 is equipped with a recording reproduction unit 19 that records the slow-motion video data generated by the image processing unit 14 and the still image data generated by the image processing unit 14 into the memory card 50 by correlating the two types of image data to each other. As a result, correlation between the two different types of image data can be sustained.

(6) The lens drive unit 21 in the digital camera 1 drives the focusing lens in the photographic lens 11 in response to a still image shooting instruction, and thus, the slow-motion video shows a change of subject image under focus adjustment. As a result, a time-series image achieving a striking motion picture effect is obtained.

(Variation 1) In the example described above, the first AF processing is executed for the closer-range subject 41 following the halfway press operation of the shutter button and the second AF processing is executed for the longer-range subject 42 following the full-press operation of the shutter button. As an alternative, the first AF processing may be executed for the longer-range subject 42 following the halfway press operation of the shutter button and the second AF processing may be executed for the closer-range subject 41 following the full-press operation of the shutter button.

(Variation 2) In addition, the first AF processing executed after the halfway press operation of the shutter button may be skipped and AF processing may be executed only following the full-press operation of the shutter button. In this case, an image group made up with a plurality of image frames with the entire image plane in a blurred state will be stored into the buffer memory 18 during the predetermined time length A elapsing before the time point t2 (i.e., prior to the full-press operation). During the predetermined time length C following the time point t3 (i.e., after the full-press operation), an image group made up with a plurality of image frames in which focus is adjusted to a specific subject, will be stored into the buffer memory 18.

In variation 2, video data achieving a striking motion picture effect whereby a blurred image plane gradually comes into focus at a specific subject can be obtained with ease.

### Second Embodiment

In the first embodiment described above, slow-motion video is generated with video shot while the focus detection position is switched. In the second embodiment, slow-motion video is generated based upon video shot during a zoom operation. Namely, AF processing is executed in response to a halfway press operation of the shutter button (at the time point t1 in FIG. 2) and zoom drive is executed (the field angle is altered) as the shutter button is pressed all the way down (from the time point t2 through the time point t3 in FIG. 2).

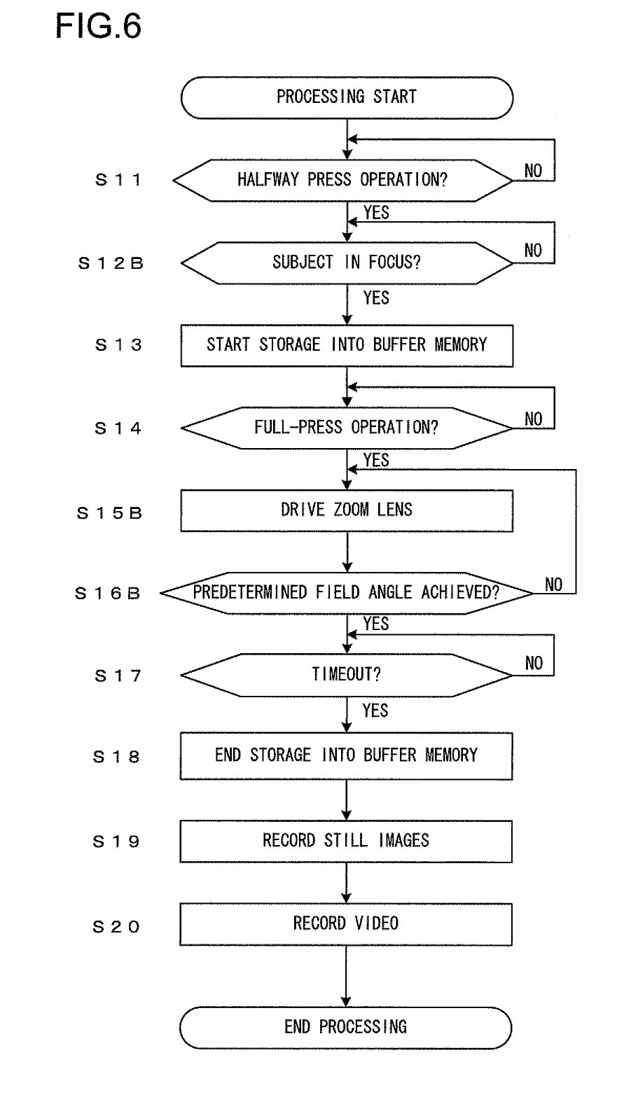

In reference to the flowchart presented in FIG. 6, the flow of processing that may be executed by the CPU 16 in the digital camera 1 in the second embodiment is described. In FIG. 6, the same step numbers are assigned to steps in which processing similar to that in the flowchart presented in FIG. 5 is executed so as to preclude the necessity for a repeated explanation thereof. Step S12b, step S15b and step S16B of the processing executed as shown in FIG. 6 differentiates it from the processing described in reference to FIG. 5. Accordingly, the following explanation focuses on these differences.

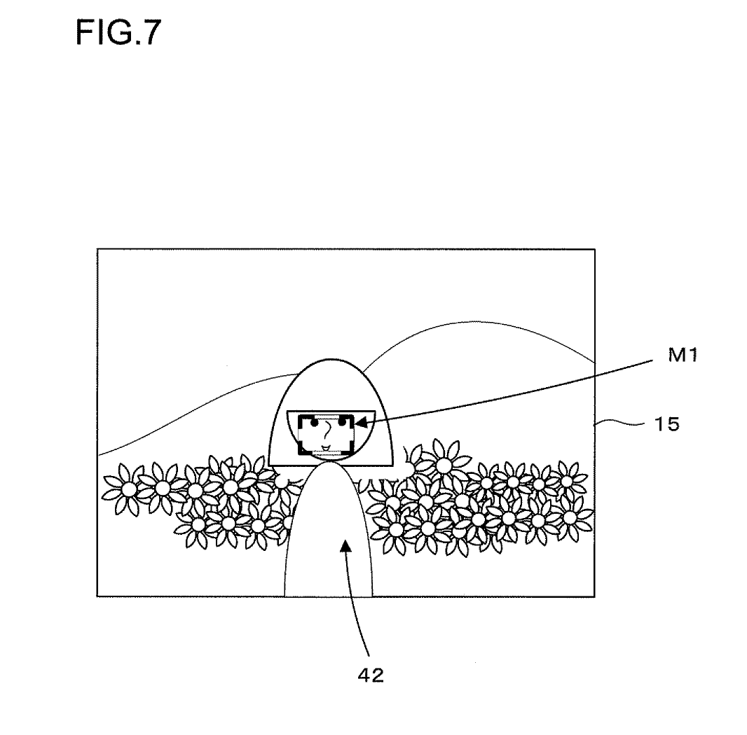

Once the slow-motion video shooting mode is selected, the CPU 16 repeatedly executes a program enabling the processing shown in FIG. 6. In the second embodiment, too, the CPU 16 accepts an operation for setting a focus detection point as an AF processing target while the live view image is up on display at the liquid crystal monitor 15. The focus detection point is set as in the example presented in FIG. 7 by moving the position of a mark M1 representing the focus detection point on the live view image is up on display at the liquid crystal monitor 15. The position of the mark M1 can be moved in correspondence to, for instance, the operating direction indicated via a cross key (not shown) included in the operation member 20. FIG. 7 shows how the mark M1 may be displayed at the liquid crystal monitor 15. In the embodiment, the focus detection point is set on, for instance, a main subject 42.

In step S12B in FIG. 6, the CPU 16 starts AF processing and makes a decision as to whether or not the main subject 42 has been in focus. Once the focusing lens is moved to the focusing position, the CPU 16 makes an affirmative decision in step S128 and proceeds to execute the processing in step S13. As a result, focus is adjusted to the main subject 42 (see FIG. 7). If, on the other hand, the focusing lens is still moving toward the focusing position, the CPU 16 makes a negative decision in step S128 and in this case, it repeatedly executes the decision-making processing.

In step S15B, the CPU 16 outputs an instruction for the lens drive unit 21, prompting the lens drive unit 21 to drive the zoom lens before proceeding to execute the processing in step S16B. The extent by which the zoom lens is moved (the extent by which the field angle is altered) in this step is determined in advance so as to ensure that the zoom lens moves to a zoom lens position at which the post drive (post zoom-in) field angle is equivalent to ½ of the pre-drive (pre-zoom-in) field angle. In addition, the zoom lens may be linearly driven through the predetermined time length B (e.g., 1 second) by sustaining a substantially constant drive speed, or the zoom lens may be driven through non-linear drive (widely known as S-characteristics drive) whereby the zoom lens is driven at low speed at the start and at the end of the predetermined time length B and the drive speed peaks halfway through the predetermined time length B.

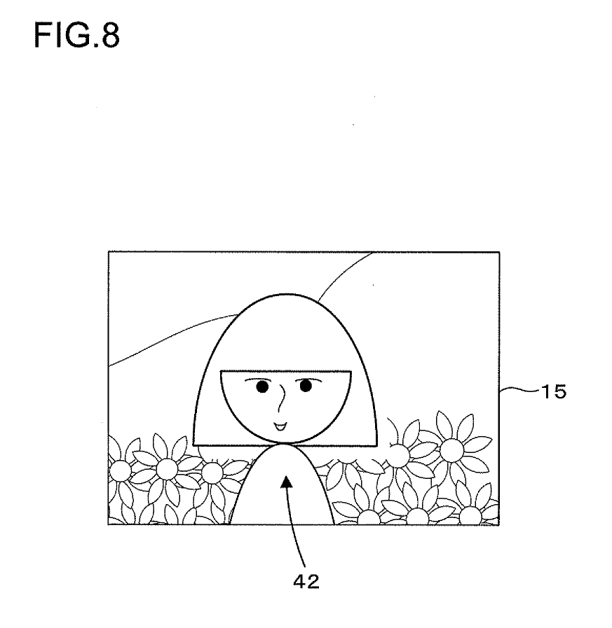

In step S16B, the CPU 16 makes a decision as to whether or not a predetermined field angle has been achieved. Once the zoom lens is moved to the zoom lens position at which the field angle is half the initial field angle assumed before the zoom lens drive, the CPU 16 makes an affirmative decision in step S16B and proceeds to execute the processing in step S17. The main subject 42 becomes zoomed up as a result (see FIG. 8). If the zoom lens is still moving toward the target zoom lens position, the CPU 16 makes a negative decision in step S16B and the operation returns to step S15B.

(Still image data) The image processing unit 14 in the second embodiment obtains first still image data constituting 3840 pixels (horizontal)×2160 pixels (vertical), by extracting a single image frame in the group of images (images captured prior to the zoom-in operation) made up with a plurality of image frames having been obtained over the predetermined length of time A elapsing before the time point t2 (i.e., prior to the full-press operation), stored into the buffer memory 18. The single image frame extracted by the image processing unit 14 may be the image in the last frame among the images obtained during the predetermined time length A or it may be a best-shot image extracted based upon predetermined selection criteria from the images obtained during the predetermined time length A.

Furthermore, the CPU 16 outputs an instruction for the image processing unit 14, prompting the image processing unit 14 to obtain second still image data constituting 3840 pixels (horizontal)×2160 pixels (vertical), by extracting a single image frame in the group of images (images captured after the zoom-in operation) made up with a plurality of image frames having been obtained over the predetermined length of time C elapsing after the time point t3 (i.e., prior to the full-press operation), stored into the buffer memory 18. The single image frame extracted by the image processing unit 14 may be the image in the first frame among the images obtained during the predetermined time length C or it may be a best-shot image extracted based upon predetermined selection criteria from the images obtained during the predetermined time length C.

The CPU 16 brings up on display at the liquid crystal monitor 15 images reproduced based upon the slow-motion video data and the first and second still image data recorded into the memory card 50 in correlation to each other as has been explained above. For instance, the CPU 16 may display the image generated based upon the first still image data for two seconds, play the video based upon the slow-motion video data for five seconds and then display the image generated based upon the second still image data over the subsequent two-second period at the liquid crystal monitor 15. It is to be noted that the second embodiment has also been described by assuming that the first recording method has been selected.

The following advantages are achieved through the second embodiment described above.

(1) The digital camera 1 is equipped with a buffer memory 18 into which a plurality of image frames, generated based upon imaging signals provided from the image sensor 12, which captures a subject image via the photographic lens 11, are sequentially stored, a lens drive unit 21 that drives the photographic lens 11 in response to a still image shooting instruction and an image processing unit 14 that generates slow-motion video data to be played back in time series at a frame rate of 24 fps, lower than the 60 fps at which the plurality of image frames are stored into the buffer memory 18 in unit time, based upon the plurality of image frames stored into the buffer memory 18 over the predetermined time length B, during which the still image shooting instruction is issued at the time point t2. Thus, a time-series image achieving a striking motion picture effect can be obtained automatically with the timing with which a still image is shot.

(2) The lens drive unit 21 in the digital camera 1 drives the zoom lens in the photographic lens 11 in response to a still image shooting instruction and thus, the slow-motion video shows a change in the subject image attributable to a change in the magnification factor. As a result, a time-series image achieving a striking motion picture effect is obtained.

(Variation 3) In the second embodiment, zoom-in drive is executed (from the time point t2 through the time point t3 in FIG. 2) in response to a full-press operation of the shutter button. As an alternative, a zoomed-in state may be assumed first and then, as the user presses the shutter button all the way down, zoom-out drive may be executed (from the time point t2 through the time point t3 in FIG. 2).

(Variation 4) While a description is given above on an example in which the field angle resulting from the zoom-in operation is half the initial field angle assumed prior to the zoom-in operation, the field angle may be altered by an extent different from ½ of the initial field angle assumed prior to the zoom-in operation. In addition, the extent to which the field angle is altered may be automatically determined by the CPU 16. In such a case, the CPU 16 may automatically determine the extent by which the field angle is to be altered by, for instance, executing “face detection” processing so as to detect the face of a person in a live view image (such as that shown in FIG. 7) prior to the zoom-in operation and determining the extent by which the field angle needs to change (the extent by which the zoom lens needs to move) to achieve a desired zoom in based upon the detection results.

The CPU 16 may determine the extent by which the field angle needs to change to achieve the desired zoom in corresponding to, for instance, the ratio of the “face” area having been detected to the photographic image plane or in correspondence to the size of the “face” area. The following is a description of an example of a method that may be adopted by the CPU 16 executing the sequence of determining the extent by which the field angle is to change. For this sequence, a setting is selected so as to allow a zooming (zoom in) operation to be executed via the zoom lens until immediately before the “face” area, having been detected within the photographic image plane, partly or entirely moves out of the photographic image plane. The CPU 16 sets the extent that the zoom lens needs to move to maximize the “face” area within the allowed zooming operation range, as the extent by which the field angle is to change. It is to be noted that while the “face” detection processing can be executed by detecting a skin-colored area, a characteristic portion such as an eye, the nose or the mouth in a face, the outline of a face or the like, these detection methods are all of the known art, and accordingly, a detailed description is not provided.

(Variation 5) In the embodiments described above, the lens drive unit 21 drives the focusing lens or the zoom lens in the photographic lens 11 while a plurality of image frames generated based upon imaging signals output from the image sensor 12, are being buffered into the buffer memory 18 sequentially (in time series). The image processing unit 14 then generates slow-motion video data based upon the resulting time-series image. However, the present invention is not strictly limited to the exact details of the embodiments and allows another photographing condition (exposure condition) to be altered. For instance, “another photographing condition (exposure condition)” such as the exposure value or the white balance value, may be altered while the plurality of image frames obtained in time series are being buffered into the buffer memory 18. “Another photographing condition” may be altered in correspondence to each image frame being buffered or it may be altered after a predetermined number of image frames are buffered. In addition, the exposure value may be altered so as to increase the extent of exposure or it may be altered so as to decrease the extent of exposure. Value settings indicating the timing with which “another photographing condition” is to change (i.e. the number of image frames captured before the change), the direction towards which the change occurs (i.e., to increase the exposure or to decrease the exposure), the extent of the change (i.e., the extent of white-out (overexposure) or the extent of blackout (underexposure)) and the like may be selected by the CPU 16 based upon draft values stored in advance in the digital camera 1 or they may be selected freely by the user via a menu screen.

Furthermore, the exposure value may be altered by driving the aperture blades, via which the size of the aperture opening is regulated, included in the photographic lens 11, the exposure value may be altered through alteration of the image-capturing sensitivity at the image sensor 12, or the exposure value may be altered through alteration of the electronic shutter speed at the image sensor. The exposure value should be altered by adopting the optimal method among these three methods listed above. For instance, when the remaining battery power is low, either of the two methods other than the “aperture blade drive”, which requires a relatively large amount of power, should be adopted. When capturing images of a highly dynamic subject, the “alteration of the electronic shutter speed (alteration of the length of time over which pixels are charged)” is less desirable than the other two methods, since it is bound to compromise the continuity among the plurality of frames of captured images. Accordingly, either of the two methods other than the “alteration of the electronic shutter speed (alteration of the length of time over which pixels are charged)” should be adopted in conjunction with a highly dynamic subject

In addition, another photographing condition (the exposure value or the white balance value) may be altered independently, as an element completely separated from the drive of the focusing lens or the zoom lens, or “another photographing condition (the exposure value or the white balance value)” may be gradually altered while the focusing lens or the zoom lens is driven. In the latter case, “another photographing condition” may be altered simultaneously as the focusing lens or the zoom lens is driven or it may be altered partially concurrently as the focusing lens or the zoom lens is driven.

For instance, while a plurality of image frames obtained in time series are being buffered (temporarily stored) into the buffer memory 18, the CPU 16 may engage the lens drive unit 21 to drive the zoom lens for a zoom in, the CPU 16 may start altering the exposure value immediately before the zoom-in drive ends and the buffering operation may end concurrently as the exposure value is gradually altered to increase the extent of exposure. Namely, there is a period of time during which the zoom lens is simply driven, followed by a period of time during which the exposure value is altered concurrently as the zoom lens is driven, followed, in turn, by a period of time during which the exposure value is continuously altered, all occurring while images are being buffered. An interesting slow-motion video, starting with images captured at a wide angle during the initial stage and gradually zooming into the target subject, with the image plane gradually taking on a lighter hue from a time point immediately before the end of the zoom-in operation and the hue of the image plane becoming increasingly white even after the end of the zoom-in operation, so as to render a white fadeout effect in the image plane, can be created by using the plurality of images buffered into the buffer memory 18 as described above.

It is to be noted that while an explanation is given above by assuming that the alteration in “another photographing condition” starts after starting the drive (zoom-in) of the photographic lens 11 (zoom lens), the alteration of “another photographing condition” may start before starting the drive of the photographic lens or the drive of the photographic lens 11 and the alteration of “another photographing condition” may start at the same time. In addition, instead of altering either the exposure value or the white balance value as “another photographing condition”, both the exposure value and the white balance value may be altered.

### Third Embodiment

The third embodiment is distinguishable from the first embodiment in that the target focus detection position to be assumed following the focus detection position shift is automatically determined by the digital camera 1. Namely, the CPU 16 determines both the first focus detection point corresponding to the initial focus detection position assumed prior to the focus detection position shift and the second focus detection point designated as the target focus detection position to be assumed after the focus detection position shift, each based upon a user operation in the first embodiment. In the third embodiment, the CPU 16 determines only the first focus detection point corresponding to the initial focus detection position based upon a user operation but automatically determines the second focus detection point designated as the target focus detection position to be assumed after the focus detection position shift on its own, i.e., without requiring any user operation.

(Focus adjustment and pre-capture operation) In the slow-motion video shooting mode, the CPU 16 stores a plurality of image frames, obtained in time series as the focus detection position is shifted, into the buffer memory 18 on a temporary basis. As soon as the slow-motion video shooting mode is selected, the CPU 16 starts a live view image display at the liquid crystal monitor 15. It is to be noted that the depth of the photographic field may be increased for the live view image display by adjusting the aperture in the photographic lens 11 until a predetermined value is achieved, so as to obtain a live view image achieving a lesser extent of blurring from the foreground through the background. However, since human “face” detection processing, which will be described in detail later, can normally be executed regardless of whether or not the target image is blurred, it is not strictly necessary to increase the depth of field in the live view image.

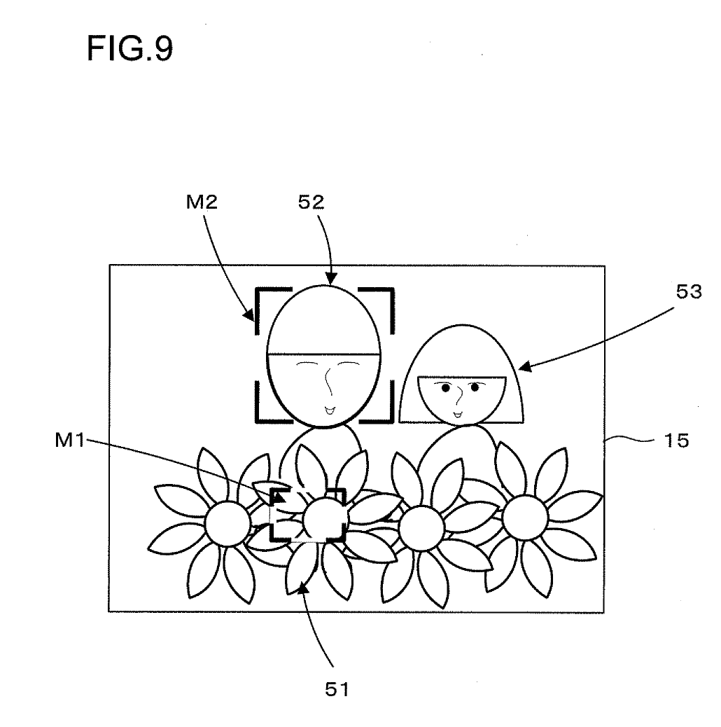

The CPU 16 executes the human “face” detection processing based upon the live view image and stores position information indicating the position of each detected “face” into the buffer memory 18. FIG. 9 presents an example of a live view image that may be brought up on display at the liquid crystal monitor 15 of the digital camera 1 achieved in the third embodiment. The example in FIG. 9 includes “faces” of a person 52 and a person 53, and accordingly, the CPU 16 stores position information for the two “faces” into the buffer memory 18.

While the live view image is up on display at the liquid crystal monitor 15, the CPU 16 accepts an operation performed so as to set a first focus detection point as the target of first AF processing to be executed in response to a halfway press operation of the shutter button. The first focus detection point is set by moving the position of a mark M1 representing the first focus detection point on a live view image on display at the liquid crystal monitor 15, as in the first embodiment. FIG. 9 illustrates how the first focus detection point may be set. The first focus detection point is set at the mark M1 positioned on a closer-range subject 51 in the embodiment. The position of the mark M1 corresponds to the initial focus detection position assumed before the focus detection position shift.

As the user presses the shutter button halfway down (switch S1 on) at the time point t1 in FIG. 2, the CPU 16 executes the first AF processing by using output signals provided from focus detection pixels corresponding to the first focus detection point. In more specific terms, the CPU 16 calculates through arithmetic operation a focusing lens drive quantity (i.e., the defocus amount) by executing AF operation based upon the output signals provided from the focus detection pixels corresponding to the first focus detection point (the position of the mark M1 in FIG. 9). The CPU 16 then engages the lens drive unit 21 so as to drive the focusing lens in the photographic lens 11 based upon the defocus amount and, as a result, focus is adjusted to the closer-range subject 51 in FIG. 9.

In addition, the CPU 16 calculates a focusing lens drive quantity (i.e. the defocus amount) through AF operation executed by using the output signals provided from focus detection pixels corresponding to each position indicated in the “face” position information stored into the buffer memory 18. The CPU 16 controls the liquid crystal monitor 15 so as to display a frame M2 in the live view image at the position of the “face” belonging to, for instance, the person 52, manifesting the least defocus amount among the plurality of detected “faces” (i.e., the “face” of the person 52 located close to the digital camera 1) and sets a second focus detection point at the position of the frame M2. In the embodiment, the position of the frame M2 corresponds to the target focus detection position to be assumed after the focus detection position shift.

Once the focusing lens is moved to the focusing position determined based upon the defocus amount calculated for the closer-range subject 51, the CPU 16 starts recording (storing) image data obtained via the image sensor 12 into the buffer memory 18. Through this process, image frames obtained at the frame rate of 60 frames/sec (60 fps) are sequentially stored into the buffer memory 18. The number of pixels constituting each image frame stored into the buffer memory 18 may be, for instance, 3840 (horizontal)×2160 (vertical).

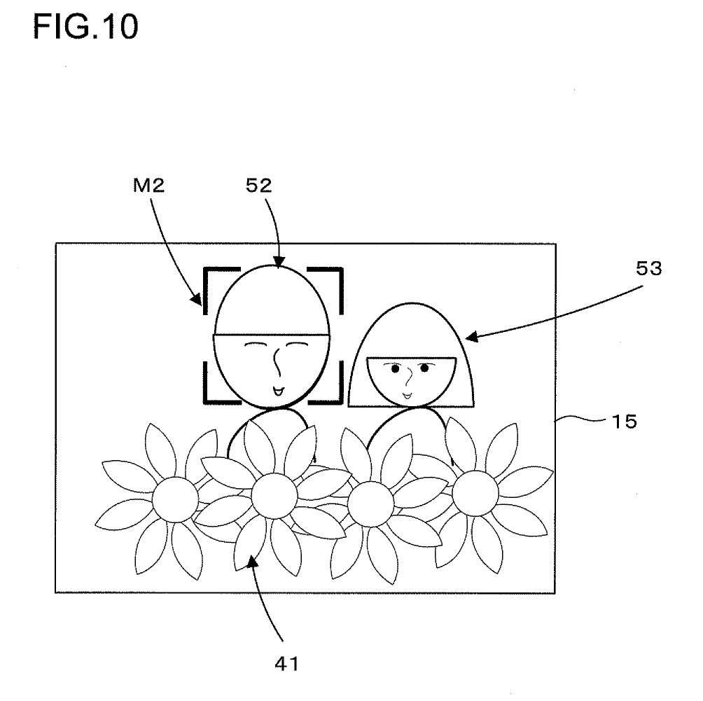

(Focus shift to a different subject) As the user presses the shutter button all the way down (switch S2 on) at the time point t2 in FIG. 2, the CPU 16 executes second AF processing. More specifically, the CPU 16 engages the lens drive unit 21 to drive the focusing lens in the photographic lens 11 based upon the defocus amount calculated for the “face” of the person 52 present at the position of the frame M2 so as to adjust focus on to the person 52 in FIG. 10. FIG. 10 illustrates how focus may be shifted to the second focus detection point. At this time, the closer-range subject 51 is outside the range of the depth of field and thus, focus is not adjusted to the closer-range subject 51 in the embodiment. A focus detection position shift operation (i.e., a condition change from the state at which the closer-range subject 51 is in focus to the state at which the person 52 is in focus) in the embodiment, started at the time point t2, is executed by the CPU 16, as it engages the lens drive unit 21 in continuous drive of the focusing lens from the time point t2 through the time point t3. While this focus detection position shift operation is in progress, the image sensor 12 is continuously engaged in image-capturing operation and image data are continuously stored (accumulated) into the buffer memory 18 on a temporary basis. The predetermined length of time B elapsing between the time point t2 and the time point t3 may be set to, for instance, one second in the embodiment.

(Post-capture operation) Once the focusing lens is driven to the focusing position determined based upon the defocus amount calculated in for person 52, the CPU 16 starts a timer count at the time point t3 via a timer circuit (not shown) within the CPU 16. At the time point t4 at which the timer circuit finishes the time count following a predetermined length of time C (e.g. 0.5 sec), the CPU 16 ends the image data accumulation in the buffer memory 18.

The following advantages are achieved through the third embodiment described above.

(1) The digital camera 1 is equipped with a buffer memory 18 into which a plurality of image frames, generated based upon imaging signals provided from the image sensor 12, which captures a subject image via the photographic lens 11, are sequentially stored, a lens drive unit 21 that drives the photographic lens 11 in response to a still image shooting instruction and an image processing unit 14 that generates slow-motion video data to be played back in time series based upon a plurality of image frames stored into the buffer memory 18 over the predetermined time length B, during which the still image shooting instruction is issued at the time point t2. Thus, a time-series image achieving a striking motion picture effect can be obtained automatically with the timing with which a still image is shot.

(2) The image processing unit of the digital camera 1 described in (1) above generates slow-motion video data to be reproduced at 24 fps, i.e., a frame rate lower than 60 fps at which the plurality of image frames are stored over unit time into the buffer memory 18. As a result, a time-series image achieving a striking motion picture effect can be obtained.

(3) The CPU 16 in the digital camera 1 automatically determines the second focus detection point to be designated as the target focus detection position to be assumed following the focus detection position shift. This means that since no user operation is required to enable the CPU 16 to determine the second focus detection point, better user convenience is assured.

(4) The CPU 16 in the digital camera 1 calculates the defocus amount to be used in the second AF processing based upon the live view image used for the first AF processing. In other words, the CPU 16 is able to calculate the defocus amount corresponding to the initial focus detection position and the defocus amount corresponding to the target focus detection position by using a single image. In other words, since the defocus amounts can be calculated without having to use two separate images, the calculation processing can be speeded up.

(Variation 6) If a plurality of main subjects (a plurality of human “faces”) is included in the image, the focus detection position may shift sequentially from one main subject to another main subject in the third embodiment. When executing the second AF processing in response to a full-press operation of the shutter button by the user (switch S2 on), the CPU 16 in variation 6 first adjusts focus at the position of the “face” of the person 52 with the smaller defocus amount (i.e., the “face” of the person 52 closer to the digital camera 1) and then adjusts focus at the position of the “face” of the person 53 with the larger defocus amount (i.e., the “face” belonging to the person 53 further away from the digital camera 1).

In variation 6, the focus detection position shifts so as to sequentially adjust focus on to each of the main subjects included in the image plane while a plurality of image frames are sequentially (in time series) stored into the buffer memory 18 on a temporary basis as the focus detection position shifts over the period of time elapsing between the time point t2 and the time point t3. While this focus detection position shift operation is in progress, the image sensor 12 is continuously engaged in image-capturing operation and image data are continuously stored into the buffer memory 18 on a temporary basis. As a result, a time-series image achieving a striking motion picture effect can be obtained.

(Variation 7) “Another photographing condition (exposure condition)”, such as the exposure value or the white balance value, may vary from one main subject area (the “face” of one person) to another main subject area (the “face” of another person) among a plurality of main subjects in the image plane in variation 6. Accordingly, the CPU 16 in variation 7 adjusts “another photographing condition” in reference to the “face” area designated as the focus adjustment target as the focus detection position shifts as described above (i.e., with the timing with which focus is adjusted to another “face”). In other words, the CPU 16 switches to the optimal exposure value so as to achieve optimal exposure for the focus adjustment target “face” and switches to the white balance value optimal for the focus adjustment target “face”.

As an alternative, the CPU 16 may alter “another photographing condition” in steps, each corresponding to one of the image frames temporarily stored into the buffer memory 18, instead of altering “another photographing condition” with the timing with which focus is adjusted to a different “face”. It is to be noted that the CPU 16 may select, in response to a user operation, a mode for altering “another photographing condition” with the timing with which focus is adjusted to a different “face” or a mode for altering “another photographing condition” in steps, each corresponding to one of the image frames temporarily stored into the buffer memory 18.

(Variation 8) When there is a plurality of main subjects (a plurality of human “faces”) present in the image plane, the direction of the focus detection position shift which the CPU 16 is to automatically detect may be determined based upon a user operation in the third embodiment. For instance, the direction of the focus detection position shift which the CPU 16 is to automatically detect may be switched to a setting of “the direction toward a subject close to the current focus detection position”. In such a case, the CPU 16 will shift the focus detection position to the main subject (to the “face” of the person 52) closest to the current focus detection position (the closer-range subject 51). The expression “closest to the current focus detection position” is used to mean that the defocus amount calculated for the particular main subject assumes a value close to that of the defocus amount calculated for the closer-range subject 51.

In addition, the direction of the focus detection position shift which the CPU 16 is to automatically detect may be switched to a setting of “the direction toward close-up prioritized” when the main subject (the “face” of the person 52) is designated as the current focus detection position. In such a case, the CPU 16 will shift the focus detection position to the subject (the closer-range subject 51 in the example presented in FIG. 9) located closest to the digital camera 1. The expression “located closest to the digital camera 1” is used to mean that the particular subject is present in closest proximity to the digital camera 1.

In the first through third embodiments described above, a slow-motion video is generated based upon a group of images obtained at a predetermined frame rate while the focus detection position shifts or while the zoom position shifts. The present invention may be adopted in conjunction with a group of images obtained through “continuous shooting” in which still images are captured successively or through “intermittent shooting” in which still images are intermittently captured, as well as in conjunction with a group of images obtained for purposes of “video” generation.

In addition, while a video for slow-motion playback is generated by using a group of images obtained while the focus detection position shifts or while the zoom position shifts in the embodiments described above, a video for regular playback, i.e., a video to be played back at the same frame rate at which the images are initially captured or a video for fast-forward playback, i.e. a video to be played back at a higher frame rate than the frame rate at which the images are initially captured, may be generated by using a group of images obtained while the focus detection position shifts or while the zoom position shifts.

Moreover, the image frames in the group of images obtained while the focus detection position shifts or while the zoom position shifts may be reproduced one image at a time as a slideshow.

(Variation 9) The first embodiment through the third embodiment and the variations thereof may be adopted in any combination. For instance, while the plurality of image frames obtained in time series are being buffered into the buffer memory 18, the focusing lens and the zoom lens may be driven simultaneously or they may be driven partially concurrently.

The embodiments described above simply represent examples and the present invention is in no way limited to the structural particulars of the embodiments. The values taken for the predetermined time length A, the predetermined time length B and the predetermined time length C may be altered as desired. For instance, they may be adjusted through a user operation performed via a setting menu screen brought up on display at the liquid crystal monitor 15.

The above described embodiments are examples, and various modifications can be made without departing from the scope of the invention.

What is claimed is:

1. An image-capturing apparatus, comprising:
a storage unit into which a plurality of image frames, generated based upon imaging signals provided from an image sensor that captures a subject image via a photographic optical system, are sequentially stored;
an optical system drive unit that drives the photographic optical system in response to a still image shooting instruction; and
a video data generation unit that generates image data to be played back in time series based upon the plurality of image frames stored into the storage unit over a predetermined time length during which the still image shooting instruction is issued.

2. An image-capturing apparatus according to claim 1, wherein:
the video data generation unit generates slow-motion video data to be played back at a second frame rate lower than a first frame rate indicating a number of image frames, among the plurality of image frames, which are stored over unit time into the storage unit.

3. An image-capturing apparatus according to claim 2, further comprising:
a still image generation unit that generates a minimum of one set of still image data based upon at least one image frame among the plurality of image frames having been stored into the storage unit over the predetermined time length.

4. An image-capturing apparatus according to claim 3, wherein:
the still image data generation unit generates the minimum of one set of still image data based upon an image frame stored into the storage unit before the optical system drive unit drives the photographic optical system and an image frame stored into the storage unit after the optical system drive unit drives the photographic optical system.

5. An image-capturing apparatus according to claim 4, wherein:
the minimum of one set of still image data generated by the still image data generation unit contains two sets of still image data; and
the still image data generation unit generates one of the two sets of still image data based upon the image frame stored into the storage unit before the optical system drive unit drives the photographic optical system and generates another of the two sets of still image data based upon the image frame stored into the storage unit after the optical system drive unit drives the photographic optical system.

6. An image-capturing apparatus according to claim 3, further comprising:
a recording control unit that records the slow-motion video data generated by the video data generation unit and the minimum of one set of still image data generated by the still image data generation unit into a recording medium by correlating the slow-motion video data with the still image data.

7. An image-capturing apparatus according to claim 1, wherein:
the optical system drive unit drives at least either a focusing lens or a zoom lens in the photographic optical system in response to the still image shooting instruction.

8. An image-capturing apparatus according to claim 1, further comprising:
an altering means for altering at least one value of an exposure value and a white balance value, wherein:
the altering means alters the at least one value while the predetermined time length over which the plurality of image frames are sequentially stored into the storage unit elapses.
